(19) United States
(12) Patent Application Publication
(10) Pub. No.: US 2006/0187891 A1
(43) Pub. Date: Aug. 24, 2006

(54) Provision of services in a communication system

(76) Inventor: Jussi-Pekka Sairanen, Saratoga, CA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/063,742

(22) Filed: Feb. 24, 2005

(51) Int. Cl. H04Q 7/24

(52) U.S. Cl. 370/338; 370/352

(57) ABSTRACT

A method for requesting a service in a communication system is provided. The method comprises requesting, via a network, information relating to a service provided via the network. The method further comprises receiving said information through a secure connection. The method further comprises storing said information in a local server application. The method further comprises requesting the service by means of the local server application using said information. Furthermore, a communication device, a network service entity, a computer program and a software development kit are configured to execute the method.

### FIELD OF THE INVENTION

The invention relates to communication systems, and more specifically to requesting and providing services in communication systems.

### BACKGROUND OF THE INVENTION

A communication system can be seen as a facility that enables communication sessions between two or more entities such as one or more communication devices and/or other nodes associated with the communication system. A communication system typically operates in accordance with a given standard or specification setting out what the various entities associated with the communication system are permitted to do and how that should be achieved. A standard or specification may define a specific set of rules, such as communication protocols and/or parameters, on which connections between the entities can be based.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS). Further examples of wireless communication systems may comprise wireless local area network (WLAN), wireless packet switched data networks, such as a wireless Internet Protocol (IP) network and so on.

A mobile communication network may logically be divided into a radio access network (RAN) and a core network (CN). The core network entities typically include various control entities and gateways for enabling communication via a number of radio access networks and also for interfacing a single communication system with one or more communication systems, such as with other wireless systems and/or fixed line communication systems. Examples of radio access networks may comprise the UMTS terrestrial radio access network (UTRAN) and the GSM/EDGE radio access network (GERAN).

Subscribers, such as the users or end-users, to a communication system may be offered and provided numerous services, such as calls, data communication or multimedia services or simply an access to a network, such as the Internet. Servers may be used in provision of the services and may be operated by an operator of a network or by an external service provider. Information servers may operate in accordance with IP protocols or other packet data protocols. A transmission protocol provides transport for application layer protocols, such as a hypertext transfer protocol (HTTP). Examples of transport, protocols suitable to run on top of IP may comprise a transmission control protocol (TCP), user datagram protocol (UDP), and stream control transmission protocol (SCTP). A wireless application protocol (WAP) may provide mobile communication devices wireless services over the Internet from fixed information servers, such as Internet servers, also called world-wide-web (www) servers or simple web servers. This may also be referred to as mobile Internet.

From a perspective of a mobile Internet user, the network connection may often be prone to breakdowns. Network problems may cut long file downloads and media streams. In addition of providing network connection, an operator might desire to have some impact to higher layers of network traffic, such as imposing tariffs and policies on the traffic.

It might be desired to improve usability of services, in particular wireless services, over the packet data networks. It might also be desired to provide new means for using and managing use of such services.

It shall be appreciated that these issues are not limited to any particular communication environment, but may occur in any appropriate communication system.

### SUMMARY OF THE INVENTION

In accordance with an aspect of the invention, there is provided a method for requesting a service in a communication system. The method comprises requesting, via a network, information relating to a service provided via the network. The method further comprises receiving said information through a secure connection. The method further comprises storing said information in a local server application. The method further comprises requesting the service by means of the local server application using said information.

In accordance with a further aspect of the invention, there is provided a method for providing information relating to a service in a communication system. The method comprises receiving, from a network, a request to provide a communication device with information relating to a service provided via the network. The method further comprises opening a secure connection to the communication device. The method further comprises providing said information through the secure connection.

In accordance with a further aspect of the invention, there is provided a computer program embodied on a computer-readable medium, said computer program configured to control a computing means to perform steps of the invention.

In accordance with a further aspect of the invention, there is provided a communication device. The communication device is configured to request information relating to a service provided via a communication system. The communication device is further configured to receive said information through a secure connection. The communication device is further configured to store said information in a local server application. The communication device is further configured to request the service by means of the local server application using said information.

In accordance with a further aspect of the invention, there is provided a communication device. The communication device comprises a transmitter for requesting information relating to a service provided via a communication system. The communication device further comprises a receiver for receiving said information through a secure connection. The communication device further comprises a local server application for storing said information. The local server application is configured to request the service using said information.

In accordance with a further aspect of the invention, there is provided a network service entity for a communication system. The network service entity is configured to receive, from a network, a request to provide a communication device with information relating to a service provided via the network. The network service entity is further configured to open a secure connection to the communication device. The network service entity is further configured to provide said information through the secure connection.

In accordance with a further aspect of the invention, there is provided a software development kit comprising means for allowing writing applications using features of an application layer protocol, the application layer protocol allowing delivery of data in response to a request for data and by means of push through a secure connection between a network service entity, which provides information relating to a service provided via a communication system, and a communication device. The software development kit may further allow creating web pages for running in the communication device to interact with the network service entity.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented;

FIG. 2 shows a flow chart illustrating an embodiment of the invention;

FIG. 3 shows a flow chart illustrating a further embodiment of the invention; and

FIG. 4 shows (a) a signalling chart illustrating a prior art implementation, and (b) a signalling chart illustrating an embodiment of the invention.

### DETAILED DESCRIPTION OF PREFERRED EMBODIMENTS

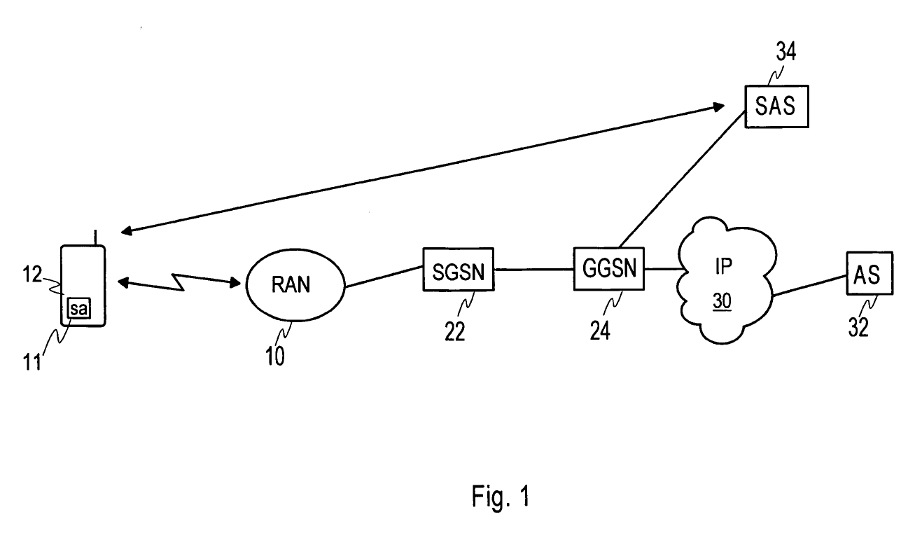

Reference is made to FIG. 1 showing an example of a network architecture in which the embodiments of the invention may be implemented. In FIG. 1, a mobile communication device 12 is arranged to access a core network via a radio access network (RAN) 10. The mobile communication device 12 may communicate via a wireless interface with at least one transceiver network element (not shown) of the RAN, such as a base transceiver station (BTS) or a Node B. A serving GPRS support node (SGSN) 22 and a gateway GPRS support node (GGSN) 24 are core network entities connecting the RAN 10 to an IP network 30.

The SGSN may be responsible for delivery of data packets to and from the communication devices within a service area. The SGSN may perform packet routing and transfer, mobility management, logical link management, authentication, charging functions, and so on. The SGSN may store location information of a communication device, such as the current cell and a visiting location register (VLR) associated with the communication device. Furthermore, the SGSN may store information on user profiles, such as the International Mobile Subscriber Identity Number (IMSI) of all the communication devices registered with the SGSN. The GGSN 24 may act as a gateway between the core network 10 and other communication systems, such as the exemplifying IP network 30.

It shall be appreciated that, although only one communication device is shown in FIG. 1 for clarity, a number of communication devices may be in simultaneous communication with one or more transceiver network elements of a communication system. A transceiver network element typically serves a geographical area or a plurality of geographical areas. Such a geographical area may also be referred to as a cell. One or more transceiver network elements may be controlled by a controller network element of the RAN, such as a base station controller (BSC) or a radio network controller (RNC). The core network (CN) entities typically include various switching and other control entities and gateways for enabling the communication via a number of radio access networks and also for interfacing a single communication system with one or more communication systems, such as with other cellular systems and/or fixed line communication systems. The controller network element is typically connected to an appropriate core network entity or entities such as, but not limited to, the exemplifying SGSN. Furthermore, although for clarity FIG. 1 shows only one radio access network, a typical communication network system usually includes a number of radio access networks. It shall be appreciated that the name, location and number of the network controllers may vary depending on the system.

An end-user may access a communication network by means of any appropriate communication device, also called terminal. Examples may comprise user equipment (UE), a mobile station (MS), a cellular phone, a personal digital assistant (PDA) and a personal computer (PC). Further examples may comprise any other equipment operable according to a suitable network or transport protocol, such as a Session Initiation Protocol (SIP), a Real-Time Transmission Protocol (RTP), a File Delivery over Unidirectional Transport (FLUTE), a wireless applications protocol (WAP), a hypertext transfer protocol (HTTP) and so on.

A communication device may be provided with an antenna or other such transceiver and receiver means for wirelessly receiving and transmitting signals from and to a transceiver network element of a wireless communication system. A communication device may also be provided with a display and a speaker. The operation of a communication device may be controlled by means of a suitable user interface comprising control means, such as a keypad, voice commands, touch sensitive screen or pad, or combinations thereof, or the like. The user interface may display a user a menu, a list or the like and allow the user to select an option from the menu. The user may indicate the selection by using the control means. The user interface may detect user activity and communicate the selection to a communicating logic of the communication device. A communication device is typically provided with a processor and memory means as well as software and applications operating the device and enabling operation with other entities. Software, which is able to request services from other entities in a communication system, may be called a client.

It has now been found that user experience of network services, in particular of the mobile Internet, might be improved by means of an application running on a communication device. Said application might provide an intermediary function between other applications of the communication device and a server of a service provider on the network side.

An example illustrates an exemplifying situation for which embodiments of the invention may provide improvements. An operator of the network may agree with a firm A to guide users to the use services of the firm A. However, to preserve a good user experience, the operator cannot bar access to another firm B providing same types of services. Instead, using the firm A should offer the users some added value, for example automatic authentication, easy billing and so on.

A web browser is a widely used network access method. Through HTTP protocol, the browser may send requests to servers, which may respond with data that a user of the browser requested. This may be referred to as a pull operation. A response may comprise one or more parts. Typically, a HTTP browser does not allow push operation, but response is sent only upon a request.

Referring back to FIG. 1, an application server (AS) 32 is shown connected to the exemplifying IP network 30. A network service entity 34, herein called also as a service agent server (SAS), has a connection to the application server 32 and to a network entity of the core network, such as to the GGSN 24. Furthermore, a local server application, called herein also a service agent (sa) 11, is implemented in the mobile communication device 12. The communication device 12 and the service agent server 34 are able to establish a secure connection, such as a connection provided by the TCP with transport layer security (TLS). The communication device 12 has a web browser or the like running on the device.

The service agent 11 runs on the communication device 12 and acts as an intermediate between the browser and the service agent server 34 and the application server 32. The service agent 11 may create locally an interactive document, such as a www-page, that a user of the communication device 12 may access, for example, using a uniform resource locator (URL). An example of such a URL might be http://localhost:1337. In an embodiment, when a user opens the www-page the URL points to, such as 127.0.0.1:1337, information, which has been created by co-operation between the service agent 11 of the communication device and the service agent server 34 in the network, may be displayed to the user. Said www-page may be named in a user interface in various different ways, for example using a descriptive name, such as “Services”. The user interface may be a web browser chosen by the user.

In an embodiment, when the service agent 11 is started, the service agent may send a contact request message in a UDP packet over a GPRS tunnelling protocol for the user plane (GTP-u) toward the GGSN 24. The GGSN 24 should recognise the packet as a service agent contact, for example, by destination address, destination or source port. The GGSN 24 may direct the packet to the service agent server 34, which may open a secure TCP/IP connection with the communication device 12. For opening the secure connection, the service agent server 34 may authenticate the mobile user sending the contact request. The contact request may contain a randomly chosen port number where the service agent 11 is listening on the communication device 12 and also a randomly chosen security code number. The service agent server 34 may establish a connection with the communication device 12 and send the security code number to validate itself. An application layer protocol used for the connection between the service agent server 34 and the communication device 12 may be named, for example a service agent protocol (SAP). The transport bearer for the SAP is provided by a secure transport protocol, such as the above-mentioned TCP with TLS. The service agent protocol allows delivery of data both in response to a request for data and by means of push. For example, SAP may allow Request/Response type function where a client requests for pieces of information. Furthermore, SAP may allow the service agent server 34 to push data to the client in the communication device 12 via the service agent 11.

The connection between the service agent 11 running on the communication device 12 and the service agent server 34 may allow, for example, push services. If the user so desires or allows, constant updates may be received, such as updates on service account state, time or place related advertising, and so on. The service agent server 34 may send the data to the service agent 11, which may turn the information into a web page form locally on the communication device.

It shall be appreciated that in this specification term service agent should be understood to comprise service agent software and possible hardware needed for implementing such function. Accordingly, term service agent server should be understood to comprise service agent server software and possible hardware needed for implementing such function.

In an embodiment, the connection between the service agent server 34, which may be operated by a network operator, for example, and the service agent 11 running on the communication device 12 is handled by the operator of the service agent server 34 directly. A software development kit (SDK) is provided to allow writing applications that utilise extra features. The SDK may provide tools for an operator to write server applications that utilise the SAP features. Furthermore, the SDK may offer an interface, such as a Javascript interface, on the client side that allows creating web pages that interact with the SAS.

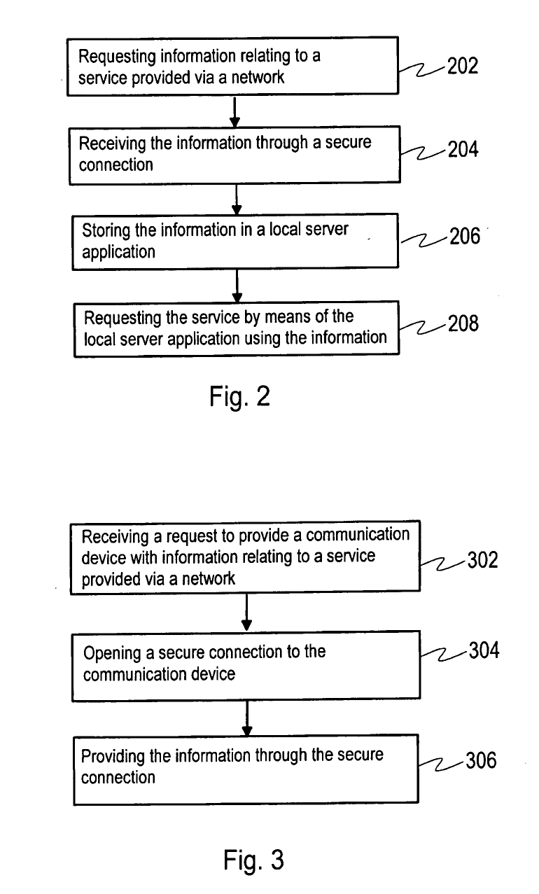

FIG. 2 shows a flow chart illustrating an embodiment of the invention. The embodiment of FIG. 2 may be seen from the communication device side. In step 202, information relating to a service provided via a network is requested via the network. For example, communication device 12 may request said information via the mobile communication network shown in FIG. 1 and comprising the radio access network 10 and the core network entities SGSN 22 and GGSN 24. The service may be a service provided by the application server 32 via the same mobile communication network. An example of said information may be, but is not limited to, a hypertext transfer protocol request string to be used in the step of requesting the service.

In step 204, said information is received through a secure connection. The secure connection is shown in FIG. 2 as the connection between the service agent server 34 and the communication device 12. The GGSN may thus forward to the SAS 34 the request for information of step 202, which the GGSN received from the communication device 12.

In step 206, said information is stored in a local server application. Referring to FIG. 1, the local server application may be the service agent 11 in the communication device 12.

In step 208, the service is requested by means of the local server application using said information.

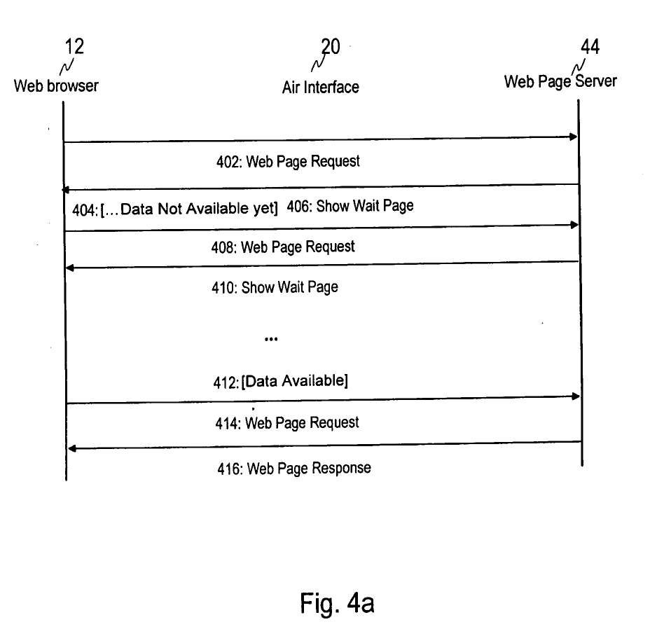

FIG. 3 shows a flow chart illustrating a further embodiment of the invention. The embodiment of FIG. 3 may be seen from side of the network service entity, such as the service agent server. In step 302, a request to provide a communication device with information relating to a service provided via the network is received from a network. In step 304, a secure connection is opened to the communication device. In step 306, said information is provided through the secure connection to the communication device.

The service agent 11 implemented in the communication device 12 may allow creating various services for a user of the communication device, in particular for a mobile user. In an embodiment, the service agent server 34 may send the communication device 12 real-time billing information packets over the service agent protocol. The service agent 11 may visualize said information on a local www-page, such as the “Services” page, for example, as a progress bar.

In an embodiment, service aware web sites may be provided. A user can have a list of web sites that cooperate with an operator. In an embodiment, a web site can have a text field, where the user can type a web site name and let the service agent 11 clarify whether said web site can be tailored for mobile user needs. For example, the user may write to the text field ‘www.hotels.com’ to initiate a query. The service agent 11 may contact the service agent server 34 over the service agent protocol. The service agent server 34 may check, if there is some cooperation with www.hotels.com. If the service agent server 34 finds that there is cooperation, the service agent server 34 may check, what kind of cooperation. Furthermore, the service agent server 34 may search all data needed in the query, such as username and location. The service agent server 34 may create and return the service agent 11 a HTTP request string. An example of such a HTTP request string might be “GET www.hotel.com?Jussi-Pekka.S@MountainViewCA-USA” The service agent 11 may then forward the HTTP request string to a “hotels.com” web server, such as the exemplifying application server 32.

In an embodiment, service aware web sites may be a selectable feature that can be chosen by a user. If the user does not want that the service provider, such as www.hotels.com, gets information on who and where the user is, the web site name, such as ‘www.hotels.com’, can be written in a text field of the browser and not in the text field of the local www-page, such as the “Services” site, which is hosted by the service agent. This may provide an advantage over a current solution in this kind of services, where the GGSN picks HTTP requests from traffic of the user and updates data of the user without asking permission from the user.

In an embodiment, a user can load to a communication device data files, for example music or video files from an operator. The application server (AS) 32 may push data through the service agent server (SAS) 34 to the client using SAP. In embodiments of the invention, SAP allows extra control over the transmission, for example by offering a user to adjust transmission speed. For example, the user may want in the midst of the download to spare data bandwidth for other purposes, such as for a phone call. Data transfer may go over SAP in a data transfer band. The user may decide to release a part of the data transfer band using a local www-page object, such as an object of the “Services” site, to lower band of downloads. This may be considered a kind of ‘do-it-yourself’ quality of service (QoS).

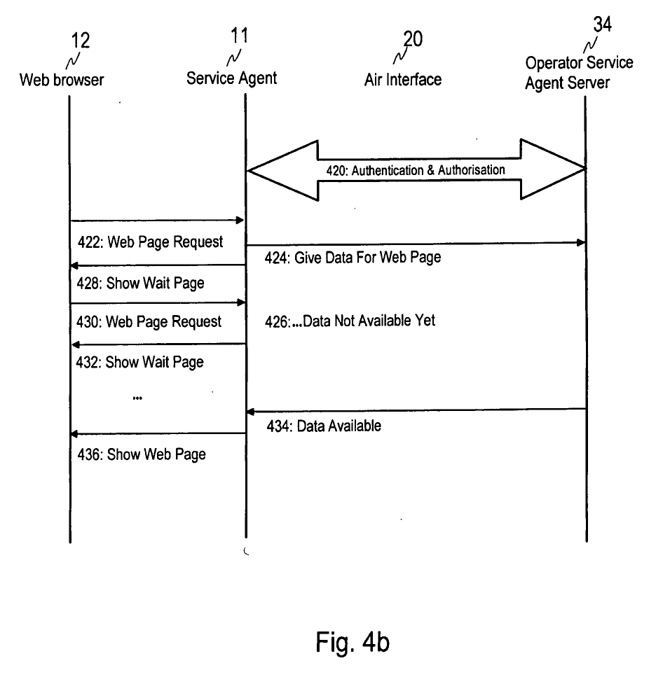

Furthermore, SAP may allow sparing the air interface. For example, when the user wants to be informed about an occurrence immediately after the occurrence, in a typical implementation using a web page, the web page needs to be refreshed every few seconds. This is illustrated in FIG. 4a. A web browser running in a communication device 12 sends a web page request 402 to a web page server 44 through the air interface 20. When data is not available as shown by reference 404, the web page server 44 sends an indication to the web browser 12, such as by showing a wait page 406. After a time period, which typically is short, such as few seconds, the web browser 12 sends a new web page request 408 and the web page server 44 shows a wait page 410 to the web browser 12 when data is not available. This is repeated until data becomes available, as indicated by reference 412. When the web browser 12 now sends a new web page request 414, the web page server 44 may send a web page response 416 comprising the requested data. Every refresh of the web page typically causes a new request/response signalling procedure with the web server over the air interface, even if most of the time the response comprises no new information.

FIG. 4b shows an embodiment of the invention enhancing the situation shown in FIG. 4a. According to embodiments of the invention, the service agent server 34 using SAP allows repeated data requests to be directed to the local service agent (sa) 11 located in the communication device 12. After an authentication and authorisation 420 between the service agent 11 and the operator service agent server 34, a web browser of the communication device 12 may send a web page request 422 to the service agent 11. The service agent 11 may send a request 424 to the operator service agent server 34 for obtaining data for a web page. As long as data is not available, as indicated by 426, the service agent shows a wait page 428, 432 in response to the web page request 422 and to a repeated web page request 430, respectively. Thus the repeated requests would not be transmitted over the air interface 20. Only when a change in data occurs, such as data becomes available 426, the service agent server 34 transmits 434 new data over SAP to the service agent 11 of the communication device 12. The service agent 11 may then forward data for showing the web page 436 in the web browser 12.

Embodiments of the invention may be performed, at least in part, by means of a computer program comprising program code means for performing any of the steps according to embodiments when the program is run on a computing means.

Embodiments of the invention may improve usability of network services, in particular the mobile Internet, in various ways. A data stream, such as music file download or video stream, may be continued exactly where the stream was left off before a network disruption. Embodiments may allow choosing a file download starting time and bandwidth according to needs of a user. For example, the user may choose to receive data for a higher fee or allow the data to arrive slowly for a lower price.

An operator may offer added value for users, such as security, automatic authentication, easy billing, and so on, and then be concerned in a content providing business. When the service agent application works in synchronization with the GGSN, the GGSN may be able to manage the network resources in a predictable way. For example, when a user requests a given high bandwidth video stream, the service agent application may ask the GGSN to reserve a piece of network bandwidth for a known duration of time. Furthermore, the operator can add push features, such as advertising, account information, and so on, in a web connection.

Although the invention has been described in the context of particular embodiments, various modifications are possible without departing from the scope and spirit of the invention as defined by the appended claims. In particular, even if a mobile telephone is mainly used as an exemplifying device providing the server, embodiments of the invention may be implemented in another appropriate communication device. Furthermore, embodiments of the invention may provide advantages when implemented in any information server, in some cases even in a fixed web server.

1. A method for requesting a service in a communication system, the method comprising:
requesting, via a network, information relating to a service provided via the network;
receiving said information through a secure connection;
storing said information in a local server application; and
requesting the service by means of the local server application using said information.

2. The method according to claim 1, wherein the step of requesting the information comprises sending a contact request message over a packet switched network.

3. The method according to claim 1, further comprising recognizing the contact request message as a contact request for a network service entity providing said information relating to said service and forwarding the contact request message to said network service entity.

4. The method according to claim 1, wherein the step of receiving the information comprises receiving said information through the secure connection provided by a secure transmission control protocol.

5. The method according to claim 4, wherein the step of receiving the information comprises receiving said information through the secure connection using an application layer protocol allowing delivery of data in response to a request for data and delivery of data by means of push.

6. A method according to claim 1, wherein the step of receiving the information comprises receiving a hypertext transfer protocol request string to be used in the step of requesting the service.

7. A method according to claim 1, further comprising creating locally an interactive document providing means for requesting said information and for requesting the service using said information.

8. A computer program embodied on a computer-readable medium, said computer program configured to control a computing means to perform the steps of:
requesting, via a network, information relating to a service provided via the network;
receiving said information through a secure connection;
storing said information in a local server application; and
requesting the service by means of the local server application using said information.

9. A communication device configured to:
request information relating to a service provided via a communication system;
receive said information through a secure connection;
store said information in a local server application; and
request the service by means of the local server application using said information.

10. A communication device comprising:
a transmitter for requesting information relating to a service provided via a communication system;
a receiver for receiving said information through a secure connection; and
a local server application for storing said information;
wherein the local server application is configured to request the service using said information.

11. A local server for a communication device, the local server configured to:
receive information relating to a service provided via a communication system;
store said information; and
request the service using said information.

12. The local server according to claim 11, further configured to provide said information to a further application in the communication device.

13. A method for providing information relating to a service in a communication system, the method comprising:
receiving, from a network, a request to provide a communication device with information relating to a service provided via the network;
opening a secure connection to the communication device; and
providing said information through the secure connection.

14. A computer program embodied on a computer-readable medium, said computer program configured to control a computing means to perform the steps of:
receiving, from a network, a request to provide a communication device with information relating to a service provided via the network;
opening a secure connection to the communication device; and
providing said information through the secure connection.

15. A network service entity for a communication system, the network service entity configured to:
receive, from a network, a request to provide a communication device with information relating to a service provided via the network;
open a secure connection to the communication device; and
provide said information through the secure connection.

16. A software development kit comprising means for allowing writing applications using features of an application layer protocol, the application layer protocol allowing delivery of data in response to a request for data and by means of push through a secure connection between a network service entity, which provides information relating to a service provided via a communication system, and a communication device.

17. The software development kit according to claim 16, wherein said means further allow creating web pages for running in the communication device to interact with the network service entity.
